(19) United States
(12) Patent Application Publication
(10) Pub. No.: US 2008/0249989 A1
(43) Pub. Date: Oct. 9, 2008

(54) Integrating a hosted services system and a search system

(75) Inventors: James Luke Silvestri, Beverly, MA (US); Jose D. Saura, Kent, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/732,874

(22) Filed: Apr. 5, 2007

(51) Int. Cl. G06F 17/30

(52) U.S. Cl. 707/3

(57) ABSTRACT

Technologies are described herein for integrating a hosted services system and a search system. A query for an entity is received at a search system. If an entry for the entity indicates that an information site does not exist for the entity, a request to create an information site for the entity is transmitted to a hosted services system. When the hosted services system receives the request, the hosted services system utilizes provided information to create a basic information site for the entity. Once the information site has been created, a network address for the information site is returned to the search system. The search system modifies an existing entry or creates a new entry for the entity that includes the provided network address. Modifications to information regarding the entity made at the hosted services system are passed to the search system for use in updating the entry.

### BACKGROUND

It can be very difficult for small businesses to create and maintain a meaningful presence on the World Wide Web (the “web”). In particular, in order to have a meaningful presence on the web, it is generally necessary for a business to have a web site and to also have the site easily locatable through the use of web search engines. As an initial matter, it can be difficult for an unsophisticated small business user to create and maintain a web site. It can be similarly difficult for a small business user to create and maintain entries for the business within various search engines.

It may also be difficult for a small business to keep information regarding the business synchronized between a web site for the business and search engines that reference the web site. For instance, when a business owner changes the phone number or other contact information for their business at their web site, the changed information will not automatically be reflected in entries for the business maintained by search systems. As a result, correct information for the business will be reflected at its web site while incorrect information will be provided by the search system.

It is with respect to these considerations and others that the disclosure made herein is provided.

### SUMMARY

Technologies are described herein for integrating a hosted services system and a search system. Through aspects presented herein, functionality provided by a hosted services system, such as functionality for creating and maintaining a hosted web site, are integrated with a search system, such as a search engine or a directory search web site. Through this integration, a small business is more easily able to create and maintain a presence on the web and, at the same time, ensure that updates to its information are reflected at the appropriate search systems.

According to one aspect presented herein, a query for an entity, such as a business, is received at a search system. In response thereto, a determination is made as to whether an entry for the entity exists at the search system that includes a link to an information page for the entity. For instance, a determination may be made by the search system as to whether a directory entry exists in a database maintained by the search system that corresponds to the entity and that includes a link to an information page for the entity.

If an entry exists at the search system for the entity that includes a link to an information page for the entity, the entry is displayed. This may include causing a selectable hyperlink to be displayed that corresponds to an information site for the entity, such as a web site. If an entry does not exist at the search system for the entity that includes a link to an information page, a request is transmitted to a hosted services system to create an information site for the entity. The request may include information to assist in the creation of the site, such as the name of the entity, an address and phone number for the entity, and other information.

The hosted services system provides hosted services, including a hosted service for creating and hosting an information site. When the hosted services system receives the request to create an information site, the hosted services system utilizes the provided information to create a basic information site for the entity. A user may be provided an opportunity to modify and supplement the created information site. Once the information site has been created, a network address for navigating to the information site is returned to the search system in response to the original request to create the information site. For instance, in one implementation the web address for the information site is provided to the search system.

When the search system receives the response from the hosted services system, the search system creates a new entry for the entity at the search system. The entry may include the provided network address for the information site created by the hosted services site. Subsequent queries for the entity received at the search system will cause the entry to be displayed, thereby providing a mechanism for navigating to the information site for the entity. If an entry already exists for the entity at the hosted services system that does not include a link to an information site for the entity, the entry may be updated to include the provided network address for the information site created by the hosted services site.

According to other aspects, a user may utilize functionality provided by the hosted services system to modify information regarding the entity on the information site. For instance, a user may modify the phone number, address, or other information for the entity at the information site. Following such a modification, the hosted services system transmits a request to the search system to update the entry associated with the entity at the search system. In response thereto, the search system updates the entry for the entity and returns an acknowledgement to the hosted services system indicating that the requested modification has been completed.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and software architecture diagram showing aspects of various computer systems and software components provided in one embodiment described herein;

FIGS. 2-3 are flow diagrams showing aspects of the operation of a hosted services system and a search system provided in one implementation described herein; and

FIG. 4 is a computer architecture diagram showing an illustrative hardware architecture suitable for implementing the computing systems described with reference to FIGS. 1-3.

### DETAILED DESCRIPTION

The following detailed description is directed to technologies for integrating a hosted services system and a search system. As will be discussed in greater detail below, a search system is integrated with functionality provided by a hosted services system for creating and hosting a web site. Through the integration described herein, a web site can be quickly created for entities not referenced by the search system. Additionally, changes to information regarding the entity made at the hosted services system are transmitted to the search system.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of technologies provided herein for integrating a hosted services system and a search system will be described.

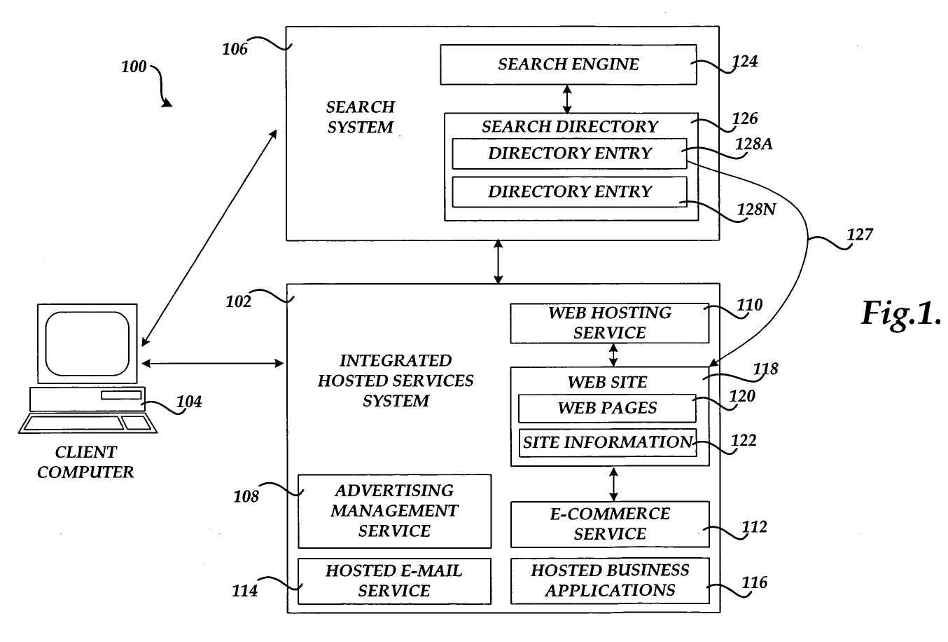

FIG. 1 is a network and software architecture diagram showing aspects of various systems and software components utilized in one embodiment presented herein. As shown in FIG. 1, aspects of the embodiments presented herein may be implemented within an integrated hosted services system 102. The integrated hosted services system 102 provides a number of hosted network services that provide integrated tools for a small business. For instance, the integrated hosted services system 102 may provide a web hosting service 110 that includes online tools for creating and hosting a web site 118 for a business. The web site 118 includes one or more web pages 120. The web site 118 may also include site information 122 that identifies an entity associated with the web site 118. For instance, the site information 122 may include the name, address, phone numbers, electronic mail (“e-mail) addresses, and other contact information for an entity associated with the web site 118.

In one implementation, the integrated hosted services system 102 also includes a hosted e-commerce service 112. The hosted e-commerce service 112 supplies back-end functionality for providing an e-commerce marketplace, including shopping cart functionality, payment processing, order tracking, and other functions. The e-commerce service 112 may integrate with the functionality provided by the web hosting service 110 to allow a small business to easily create a web page 120A through which goods or services may be offered for sale.

According to other aspects, the integrated hosted services system 102 may also provide other types of hosted network services. For instance, in one implementation, the integrated hosted services system 102 may also provide a hosted e-mail service 114. The e-mail service 114 allows a business to host e-mail accounts for their domain at the integrated hosted services system 102. The integrated hosted services system 102 may also include other hosted business applications 116, such as a hosted calendar, hosted to-do lists, hosted collaboration services, and other types of hosted business applications. A client computer 104 may connect to the integrated hosted services system 102 using a web browser application program to access the functionality provided by the web hosting service 110, the hosted e-mail service 114, and the other hosted business applications 116.

As also shown in FIG. 1, the hosted services system 102 may be integrated with a search system 106. The search system 106 provides functionality for searching the web or other type of database. In this regard, the search system 106 provides a search engine 124 that may be accessed through the web by a web browser executing on the client computer 104. Through the search engine 124, a search may be made of a database that stores content retrieved from the web. In an alternate embodiment, the search engine 124 may be utilized to query a search directory 126. The search directory 126 is a directory having one or more entries 128A-128N stored therein. Each directory entry 128 corresponds to an entity. An entity identified by an entry may be an organization, such as a business or not-for-profit group, or an individual. Each of the entries 128A-128N includes data identifying the referenced entity, such as the name of the entity, address, phone number, and other contact information. A directory entry 128A may also include a hyperlink 127 directed toward a web site 118 maintained by the referenced entity. In one embodiment, the search directory 126 is organized geographically, thereby allowing a user to quickly search for entities in their own local area.

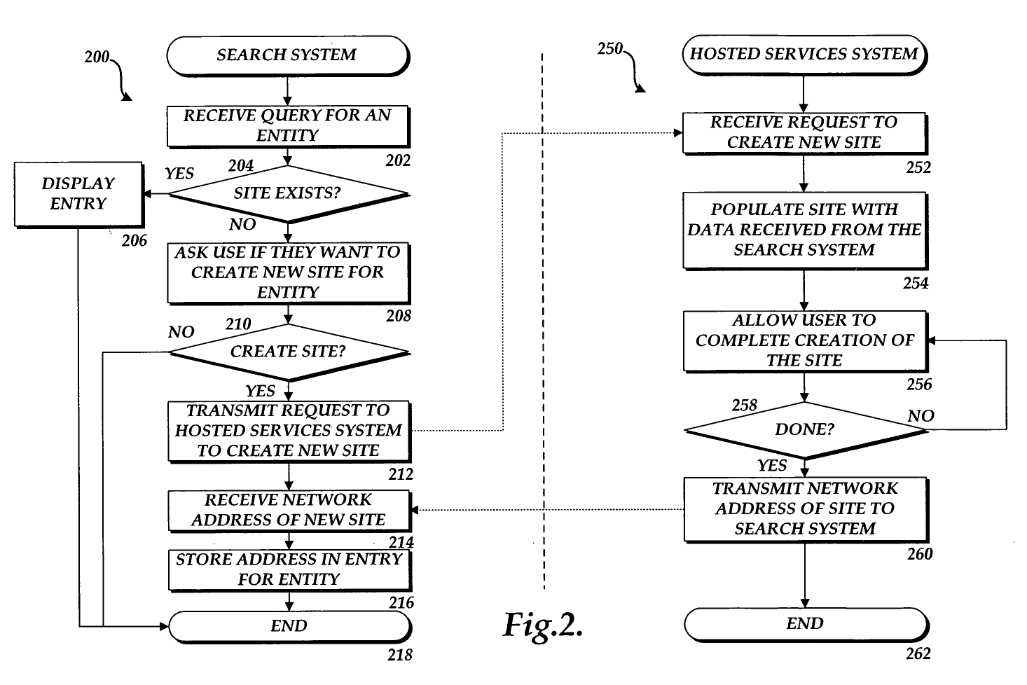

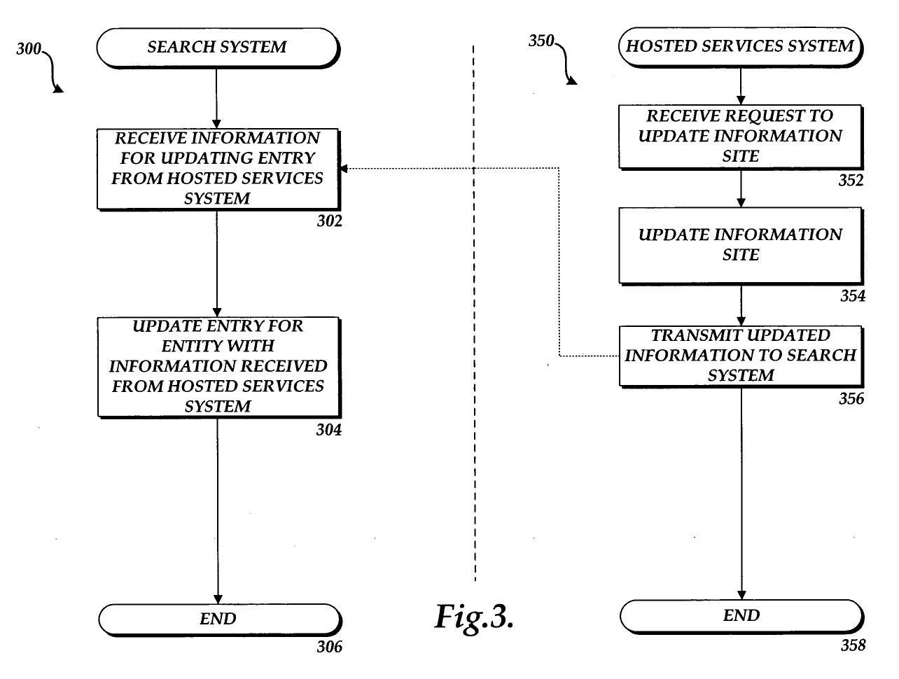

As will be described in greater detail below with reference to FIGS. 2 and 3, the search system 106 and the hosted services system 102 are integrated. Through their integration, a user of the client computer 104 may query the search system 106 for an entity. If the entity is not located in the search directory 126 or if the entry for the entity does not include a reference to a web site, the user may be prompted to create a web site 118 at the hosted services system 102 for the entity. If the user elects to create the web site 118, the search system 106 redirects the user to the web hosting service 110, where the web site 118 is created. Once the web site 118 has been created, the network address of the web site 118, such as the hyperlink 127, is returned to the search system 106 for inclusion in an entry 128A corresponding to the entity. Additionally, any changes subsequently made to the site information 122 are transmitted to the search system 106 for use in updating the entry 128A corresponding to the entity. Additional details regarding theses processes are provided below with respect to FIGS. 2 and 3.

Referring now to FIG. 2, additional details will be provided regarding the operation of the search system 106 and the hosted services system 102. In particular, FIG. 2 is a flow diagram showing a routine 200 that illustrates aspects of the operation of the search system 106 and a routine 250 that illustrates aspects of the operation of the hosted services system 102. It should be appreciated that the logical operations described herein with respect to FIGS. 2-3 are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in FIG. 2-3 and described herein. These operations may also be performed in a different order than those described herein with respect to FIGS. 2-3.

The routine 200 begins at operation 202, where a query is received at the search engine 124 for an entity. For instance, a user of the client computer 104 may query the search engine 124 for the name of a business that they own or are otherwise associated with. From operation 202, the routine 200 continues to operation 204, where the search engine 124 makes a search of the directory 126 for the specified entity. The search engine 124 also determines whether an entry 128 for the specified entity was located in the directory 126. If an entry 128 was located in the directory 126, the routine 200 proceeds from operation 204 to operation 206, where the located entry is displayed. This may entail, for instance, causing the data stored in the located entry to be shown at the client computer 104. If a hyperlink to an information site associated with the entity is present in the located entry, the hyperlink may also be displayed. In this manner, the name, address, phone number, network address, and other information stored in the located entry are made available to the user of the client computer 104. From operation 206, the routine 200 continues to operation 218, where it ends.

If, at operation 204, the search engine 124 determines that an entry for the specified entity was not located in the search directory 126 or if an entry was located that does not include a hyperlink to an information site, the routine 200 continues from operation 204 to operation 208. At operation 208, the search system 106 asks the user of the client computer 104 if they would like to create an entry for the entity and an information site for the entity. An information site is a web site or other type of network-accessible site through which information may be obtained for an entity. In the implementation described herein, the information site is a web site. It should be appreciated, however, that other types of information sites may also be utilized.

If the user indicates that they would not like to create a web site, the routine 200 proceeds from operation 210 to operation 218, where it ends. If the user indicates that they would like to create an entry and a web site for the entity, basic information regarding the entity is received from the user. For instance, the name, address, phone number, e-mail address, and other contact information for the entity may be received. Once this information has been received, a new directory entry 128A is created in the search directory 126 for the entity. The routine 200 then proceeds from operation 210 to operation 212.

At operation 212, the search system 106 transmits a request to the web hosting service 110 to create a new web site for the entity. The basic information for the entity, such as its name, address, and phone numbers, may be transmitted to the web hosting service 110 along with the request. The web hosting service 110 receives the request at operation 252 of the routine 250. As discussed briefly above, the web hosting service 110 provides an interface for creating a web site. The web hosting service 110 also provides functionality for hosting the site once it has been created. From operation 252, the routine 250 continues to operation 254.

At operation 254, the web hosting service 110 creates and populates a web site 118 with the information received from the search system 106 in the initial request to create a site. The web hosting service 110 may maintain web site templates for use in creating a site in this manner. The templates may provide a basic layout for the site and specify a location for the name, address, phone numbers, and other information for the entity. In this manner, a web site for the entity can be created very quickly with little or no user intervention.

From operation 254, the routine 250 continues to operation 256, where a user of the client computer 104 is provided an opportunity to complete the creation of the web site 118. In this regard, the web hosting service 110 may provide functionality for allowing a user to rearrange the web site 118, add new web pages, insert or remove content, and to otherwise customize the site. From operation 256, the routine 250 continues to operation 258, where the web hosting service 110 determines whether the user has completed the site. If not, the routine 250 returns back to operation 256. If the user has completed the site, the routine 250 continues to operation 260.

At operation 260, the web hosting service 110 transmits a network address for the newly created web site 118 to the search system 106. The network address may comprise a hyperlink 127 to the new web site 118 or another type of network address that may be utilized to navigate to a different type of information site. At operation 214 of the routine 200, the search system 106 receives the network address of the newly created web site 118. The routine 200 then continues to operation 216, where the search system 106 stores the network address of the web site 118 in the directory entry 128A for the entity. On subsequent searches of the search directory 126 for the entity, the data stored in the directory entry 128A will be displayed, including the hyperlink 127 for navigating to the web site 118. From operation 216, the routine 200 continues to operation 218, where it ends. The routine 250 continues from operation 260 to operation 262, where it ends.

According to other implementations, a user of the client computer 104 may query the search engine 124 for an entity. If an entry 128A does exist for the entity, but no web site is referenced by the entry 128A, the user may be prompted to create a web site for the entity. If the user chooses to create a web site, the site is created in the as described above. In this manner, a web site may be created for an entity regardless of whether a directory entry for the entity is preexisting in the search directory 126.

Turning now to FIG. 3, an illustrative routine 300 will be described that illustrates additional aspects of the operation of the search system 106 along with a routine 350 that illustrates additional aspects of the operation of the hosted services system 102. The routine 350 begins at operation 352, where the web hosting service 110 receives a request to update the site information 122 stored at the web site 118. Such a request may come, for instance, from a user of the client computer 104 that desires to update the name, address, phone number, or other information for the entity associated with the web site 118. In response to such a request, the routine 350 continues from operation 352 to operation 354, where the updated information is received. The updated information is then utilized to update the site information 122 and any of the web pages 120 on the web site 118.

From operation 354, the routine 350 continues to operation 356, where the web hosting service 110 transmits a request to the search system 106 to update an entry 128A with the updated information. The request is received by the search system 106 at operation 302 of the routine 300. The routine 300 then continues to operation 304, where the search system 106 updates the appropriate entry 128A in the search directory 126 with the modified information. In this manner, modifications to information associated with an entity that are made at the web hosting service 110 are reflected in the entries 128A-128N maintained at the search system 106. From operation 304, the routine 300 continues to operation 306, where it ends. From operation 356, the routine 350 continues to operation 358, where it ends.

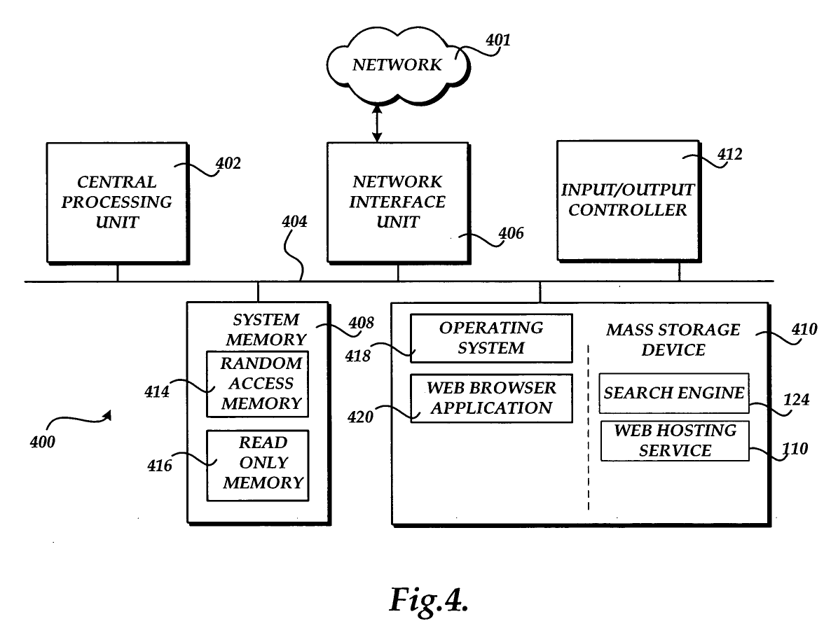

Referring now to FIG. 4, an illustrative computer architecture for a computer 400 capable of executing the software components described above with respect to FIGS. 1-3 will be discussed. The computer architecture shown in FIG. 4 illustrates a conventional desktop, laptop computer, or server computer, and may be utilized to embody the client computer 104, computers utilized at the search system 106, or computers utilized within the integrated hosted services system 102.

The computer architecture shown in FIG. 4 includes one or more central processing units 402 (“CPUs”), a system memory 408, including a random access memory 414 (“RAM”) and a read-only memory (“ROM”) 416, and a system bus 404 that couples the memory to the CPU 402. A basic input/output system containing the basic routines that help to transfer information between elements within the computer 400, such as during startup, is stored in the ROM 416. The computer 400 further includes a mass storage device 410 for storing an operating system 418, application programs, and other program modules, which will be described in greater detail below.

The mass storage device 410 is connected to the CPU 402 through a mass storage controller (not shown) connected to the bus 404. The mass storage device 410 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available media that can be accessed by the computer 400.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network such as the network 401. The computer 400 may connect to the network 401 through a network interface unit 406 connected to the bus 404. It should be appreciated that the network interface unit 406 may also be utilized to connect to other types of networks and remote computer systems. The computer 400 may also include an input/output controller 412 for receiving and processing input from a number of other devices, including a keyboard, mouse, or electronic stylus (not shown in FIG. 4). Similarly, an input/output controller may provide output to a display screen, a printer, or other type of output device (also not shown in FIG. 4).

As mentioned briefly above, a number of program modules and data files may be stored in the mass storage device 410 and RAM 414 of the computer 400, including an operating system suitable for controlling the operation of a networked desktop, laptop, or server computer. The mass storage device 410 and RAM 414 may also store one or more program modules. In particular, the mass storage device 410 and the RAM 414 may store a web browser application 420, the search engine 124 and the web hosting service 110, each of which has been described above with reference to FIGS. 1-3. Other program modules may also be stored in the mass storage device 410 and utilized by the computer 400.

Based on the foregoing, it should be appreciated that technologies for integrating a hosted services system and a search system are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for integrating a hosted services system with a search system, the method comprising:
receiving a query for an entity at the search system;
determining whether an entry for the entity exists at the search system;
in response to determining that an entry does not exist for the entity at the search system, transmitting a request to the hosted services system to create an information site for the entity, receiving a network address of the information site from the hosted services system, and creating a new entry for the entity at the search system, the entry including the network address of the information site.

2. The method of claim 1, further comprising in response to determining that an entry does exist for the entity at the search system, causing a selectable link to the information site to be displayed, the selectable link including the network address of the information site.

3. The method of claim 1, further comprising:
receiving a request from the hosted services system to update the entry for the entity; and
updating the entry for the entity at the search system in response to receiving the request.

4. The method of claim 1, wherein the hosted services system provides a hosted service capable of creating and hosting the information site.

5. The method of claim 4, wherein the information site comprises a web site generated by the hosted service.

6. The method of claim 5, wherein the request to create an information site for the entity comprises data for creating the information site.

7. A computer-readable medium having computer-executable instructions stored thereon which, when executed by a computer, cause the computer to perform the method of claim 1.

8. A method for integrating a hosted services system with a search system, the method comprising:
receiving a request from the search system to create an information site for an entity;
in response to the request, creating an information site for the entity at the hosted services system; and
transmitting a network address for accessing the information site to the search system.

9. The method of claim 8, further comprising:
receiving a request to update the information site at the hosted services system; and
in response to receiving the request, updating the information site and transmitting a request to the search system to update an entry at the search system associated with the information site.

10. The method of claim 8, wherein the hosted services system provides a hosted service capable of creating and hosting the information site.

11. The method of claim 10, wherein the information site comprises a web site generated by the hosted service.

12. The method of claim 11, wherein the request to create an information site for the entity comprises data for creating the information site.

13. A computer-readable medium having computer-executable instructions stored thereon which, when executed by a computer, cause the computer to perform the method of claim 8.

14. A method for integrating a hosted services system with a search system, the method comprising:
receiving a query for an entity at the search system;
determining in response to the query whether a directory entry exists at the search system for the entity;
in response to determining that a directory entry does not exist at the search system for the entity, transmitting a request to the hosted services system to create an information site for the entity;
receiving the request to create an information site for the entity at the hosted services system and, in response to the request, creating an information site for the entity at the hosted services system and transmitting a network address for accessing the information site to the search system;
receiving the network address of the information site at the search system; and
creating a new directory entry for the entity at the search system, the directory entry including the network address of the information site.

15. The method of claim 14, further comprising in response to determining that a directory entry does exist at the search system for the entity, causing a selectable link to the information site to be displayed, the selectable link including the network address of the information site.

16. The method of claim 15, further comprising:
receiving a request to update the information site at the hosted services system; and
in response to receiving the request, updating the information site and transmitting a request to the search system to update the directory entry at the search system for the information site.

17. The method of claim 16, further comprising:
receiving the request from the hosted services system to update the directory entry for the entity; and
updating the directory entry for the entity at the search system in response to receiving the request.

18. The method of claim 17, wherein the information site comprises a web site generated by a hosted service executing at the hosted services system.

19. The method of claim 18, wherein the request to create an information site for the entity comprises data for creating the information site.

20. A computer-readable medium having computer-executable instructions stored thereon which, when executed by a computer, cause the computer to perform the method of claim 14.
